(19) United States
(12) Patent Application Publication
(10) Pub. No.: US 2019/0070860 A1
(43) Pub. Date: Mar. 7, 2019

(54) PRINT DEVICE WITH VALVE IN PRINT FLUID SUPPLY PATHWAY

(71) Applicant: Hewlett-Packard Development Company, L.P., Houston, TX (US)

(72) Inventors: Carlos Chover Lopez, Sant Cugat del Valles (ES); Emilio Jose Gongora Canada, Sant Cugat del Valles (ES); Marta Coma Vives, Sant Cugat del Valles (ES)

(73) Assignee: Hewlett-Packard Development Company, L.P., Houston, TX (US)

(21) Appl. No.: 15/762,020

(22) PCT Filed: Jan. 29, 2016
(86) PCT No.: PCT/EP2016/051997

§ 371 Date: Mar. 21, 2018

(51) Int. Cl. B41J 2/175

(52) U.S. Cl. CPC B41J 2/17596; B41J 2/17506

(57) ABSTRACT

In one example, there is disclosed a print device 100 comprising: a print fluid supply pathway 102 extending from a reservoir inlet 104 to a printhead outlet 106; a valve 108 in the print fluid supply pathway 102 downstream of the reservoir inlet 104: a pressure sensor 110 to monitor print fluid pressure upstream of the valve 108; a pressure sensor controller 112 to temporarily close the valve 108 for a closed period and monitor print fluid pressure using the pressure sensor 110 during the closed period; and a print operation controller 114 to control printing operations of the print device 100 so that in use a printing operation continues and print fluid is discharged from a printhead 234 during a closed period of the valve 108 in the respective print fluid supply pathway 102.

### BACKGROUND

Print devices such as inkjet printers and 3D (three-dimensional) printers for additive manufacturing deliver droplets of ink or print fluid through nozzles onto a substrate, such as paper or a layer of powder for forming. Large format inkjet printers, such as those for printing on large format sheet media including A1 and above, may have an ink supply remote from a moveable carriage and printhead of the printer, and an ink supply pathway extending from the ink supply to the printhead, such as flexible tubing. Similarly, 3D printers may have a print fluid supply remote from a movable carriage and printhead of the printer.

### BRIEF DESCRIPTION OF DRAWINGS

Examples will now be described, way of non-limiting example, with reference to the accompanying drawings, in which:

FIGS. 1 to 3 are simplified schematics of example print devices;

FIG. 4 is a simplified schematic of an example print device controller;

FIGS. 5 to 7 are flowcharts of example methods of pressure monitoring during printing; and

FIG. 8 is a simplified plot showing overlapping print fluid discharge and closed periods of a valve.

### DETAILED DESCRIPTION

Additive manufacturing techniques may generate a three-dimensional object through the solidification of a build material. The build material may be powder based and the properties of generated objects may depend on the type of build material and the type of solidification mechanism used. In a number of examples of such techniques including sintering techniques, build material is supplied in a layer-wise manner and the solidification method includes heating the layers of build material to cause melting in selected regions. In other techniques, chemical solidification methods may be used.

Additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to generate slices of parallel planes of the model. Each slice may define a portion of a respective layer of build material that is to be solidified or caused to coalesce by the additive manufacturing system.

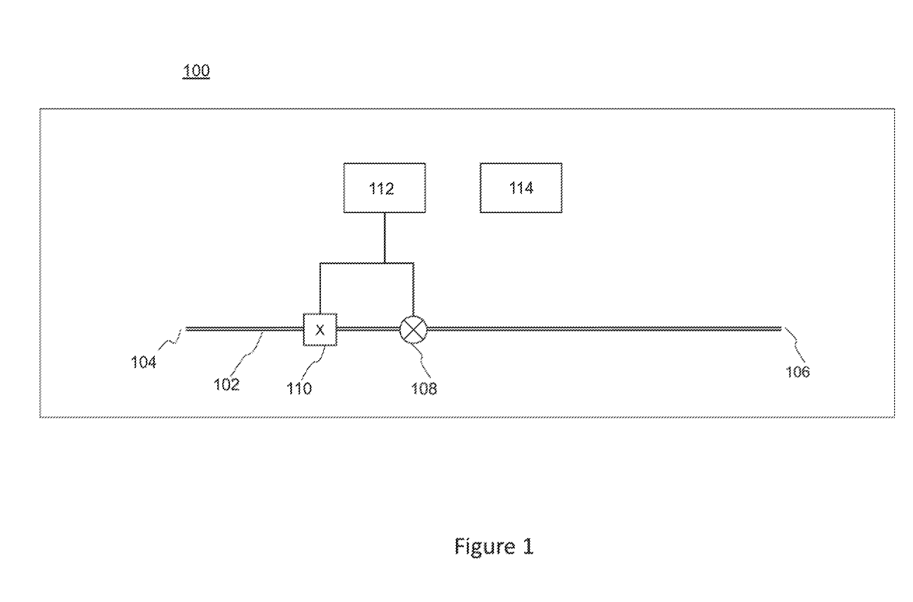

FIG. 1 shows an example print device 100 comprising a print fluid supply pathway 102 extending from a reservoir inlet 104 to a printhead outlet 106. The reservoir inlet 104 may be coupled to a print fluid reservoir and the printhead outlet 106 may be coupled to a printhead of the print device 100, which may be replaceable components.

A valve 108 is disposed in the print fluid supply pathway 102 downstream of the reservoir inlet 104 to controllably open and close the print fluid supply pathway 102 to allow and inhibit print fluid flux therethrough respectively.

A pressure sensor 110 is disposed upstream of the valve 108 to monitor print fluid pressure in the portion of the print fluid supply pathway 102 upstream of the valve 108. In this example the pressure sensor 110 is disposed downstream of the reservoir inlet 104, but in other examples the pressure sensor 110 may monitor print fluid pressure upstream of the reservoir inlet, for example in a reservoir coupled to the reservoir inlet 104.

In this example, the valve 108 and pressure sensor 110 are coupled to a pressure sensor controller 112. The pressure sensor controller 112 is provided to temporarily close the valve for a closed period, after which it is subsequently re-opened, and to monitor print fluid pressure using the pressure sensor during the closed period. Accordingly, the print fluid pressure is monitored whilst the respective portion of print fluid (i.e. the print fluid upstream of the valve 108) is not flowing, and so the static pressure recorded by the pressure sensor is equivalent to the total pressure of the print fluid (i.e. static pressure plus dynamic pressure). Consequently, a pressure parameter monitored by the pressure sensor (i.e. a value indicative of or related to the print fluid pressure) may reliably reflect the pressure of the print fluid and is independent of whether the print fluid downstream of the valve 108 is currently being used in a printing operation (i.e. being discharged from a printhead). In this example, the pressure sensor controller 112 is to monitor print fluid pressure only during closed periods of the valve, so that that the static pressure recorded by the pressure sensor is equivalent to the total pressure of the print fluid. However, it will be appreciated that in other examples, the pressure sensor controller 112 may additionally initiate pressure monitoring outside of a dosed period of the valve, for example, to monitor the dynamic component of pressure, or when it is known that there is no flow of the respective print fluid, or for other purposes.

A print operation controller 114 is also provided to control print operations of the print device during which print fluid is discharged from a printhead. In this example, the pressure sensor controller 112 and print operation controller 114 operate so that in use, the pressure sensor controller can monitor pressure during a print operation. In particular, pressure can be monitored whilst print fluid from the respective print fluid supply pathway is discharged from a printhead.

In this example, the print operation controller 114 and pressure sensor controller 112 operate substantially independently of each other, so that, once a print operation is initiated, the pressure sensor controller 112 can monitor pressure using the pressure sensor 110 without the print operation being paused. Similarly, the pressure sensor controller may operate to monitor print fluid pressure periodically and independently of whether the respective print fluid is being used in a print operation. The valve may be closed during a print operation, specifically whilst print fluid is being discharged from the respective print fluid supply pathway. Accordingly, the pressure sensor controller can initiate pressure monitoring without awaiting a pause in, or completion of, a printing operation.

Monitoring print fluid pressure may, amongst other things, enable the proper functioning of the print device, availability of print fluid, capacity of an print fluid reservoir and/or progress of a reservoir re-fill operation to be checked.

The print device 100 may be an inkjet printer or a 3D printer (a three-dimensional printer for additive manufacturing). In an example the print device 100 may be an inkjet printer to discharge ink on sheet media, such as paper and the print fluid may be ink.

In a further example, the print device 100 may be a 3D printer to produce a 3D article by forming successive layers of an article bound together and the print fluid may be a binding agent. In use, the 3D printer may discharge the binding agent through a printhead so that the binding agent is applied to a substrate, such as a layer of forming powder for a 3D print operation, in order to locally bond the substrate as part of a 3D print operation.

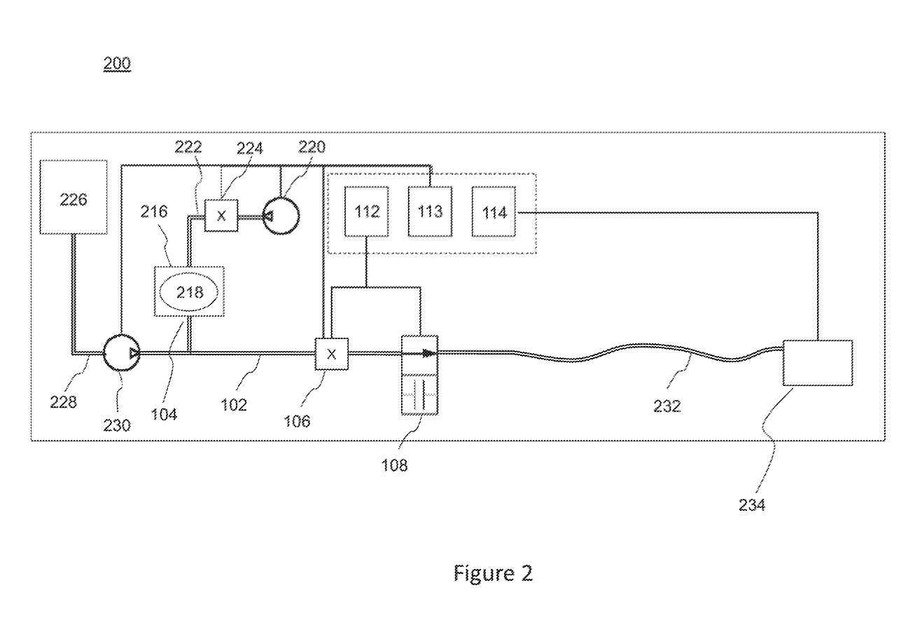

FIG. 2 shows a further example of a print device 200, which in this example is an inkjet printer. In the example print device 200, there is a print fluid supply pathway 102, valve 108 and pressure sensor 106 as described above with respect to FIG. 1, as well as a pressure sensor controller 112 and a print operation controller 114.

In this example, the print fluid supply pathway 102 is coupled at the reservoir inlet 104 to a print fluid reservoir 216. In this example, the print fluid reservoir 216 comprises a flexible print fluid bladder 218 disposed within a housing of the reservoir 216. An air pump 220 is fluidically coupled to the interior of the housing by an air supply line 222, and an air pressure sensor 224 is disposed in the air supply line 222 for monitoring the air pressure. The bladder 218 can be compressed by air pumped by the air pump 220 into the housing so that print fluid is supplied from the bladder 218 along the print fluid supply pathway. For example, the air pump may be operated based on feedback from the pressure sensor controller 112 to maintain the print fluid pressure in the print fluid supply pathway within a target range, such as between 10 kPa and 50 kPa gauge (i.e. above atmospheric pressure).

In this example, there is also a print fluid supply 226 containing print fluid and fluidically coupled to the print fluid supply pathway 102 by a refill line 228. In this example, there is a junction of the refill line 228 and the print fluid supply pathway 102 between the reservoir inlet 104 and the pressure sensor 110. In other examples, the refill line 228 may extend directly into the reservoir 216. A refill pump 230 is disposed in the refill line 228 for pumping print fluid on demand from the print fluid supply 226 to the print fluid reservoir 216. A refill controller 113 is provided for initiating and controlling refill of the print fluid reservoir 216 from the print fluid supply 226, and is coupled to the air pump 220, print fluid pump 230 and pressure sensor 106 accordingly.

Accordingly, the print fluid reservoir 216 can be refilled from the print fluid supply 226. For example, the fill status of the reservoir may be determined based on feedback from the pressure sensor controller 112, and a refill operation in which print fluid is supplied from the print fluid supply 226 to the print fluid reservoir 216 may be conducted.

In this example, the pressure sensor 106 is a pressure transducer having a pressure-sensitive surface exposed within the print fluid supply pathway 102. In other examples, any suitable pressure sensor can be used. The pressure sensor 106 may be linked to the air pressure sensor 224 to obtain a gauge reading relative air pressure, and/or both sensors 106, 224 may be coupled to the pressure sensor controller so that the pressure sensor controller can make a comparison to obtain a gauge reading accordingly.

In this example, the valve 108 is a solenoid valve which is set to be normally open and can be actuated to temporarily close. The valve 108 is to close by moving from an open configuration (in which fluid may flow therethrough) to a closed configuration (in which fluid flow therethrough is stopped) in a period of approximately 50 ms. In other examples, this period may be less than 50 ms, for example 20 ms or less, 10 ms or less, 5 ms or less, or 2 ms or less. The valve 108 can be opened in a corresponding time period.

The valve 108 and components upstream of the valve (e.g. the print fluid supply 226 and reservoir 216, the pressure sensor) may be disposed in a part of the print device away from a moveable carriage and printhead 234 of the print device, such as in a print fluid supply cabinet disposed below the carriage and any sheet media feeding apparatus of the print device. Similarly, the pressure sensor controller 112 and the print operation controller 114 may be located away from the moveable carriage, for example in a control unit of the print device 200. Such a control unit may be located in any suitable location, such as in or adjacent to a print fluid supply cabinet, or behind a user interface panel of the print device 200.

In this example, downstream of the valve 108, the print fluid supply pathway 102 comprises flexible tubing 232 which extends from the valve 108 to the printhead 234 supported on the moveable carriage. The moveable carriage and printhead 234 are coupled to the print operation controller 114 so that they may be controlled to traverse sheet media during a print operation and discharge print fluid onto the sheet media during the print operation.

In this example, the print device 200 is a large format inkjet printer and the length, and therefore the fluid capacity, of the flexible tubing 232 is relatively large. In this particular example, the flexible tubing 232 is approximately 5-6 m in length between the valve 108 and printhead 234, and holds approximately 100 ml of ink (print fluid). In this example the internal diameter of the flexible tubing 232 is approximately 4-5 mm. In other examples the print fluid supply pathway downstream of a valve may have a different fluid capacity, such as between 20 ml and 300 ml.

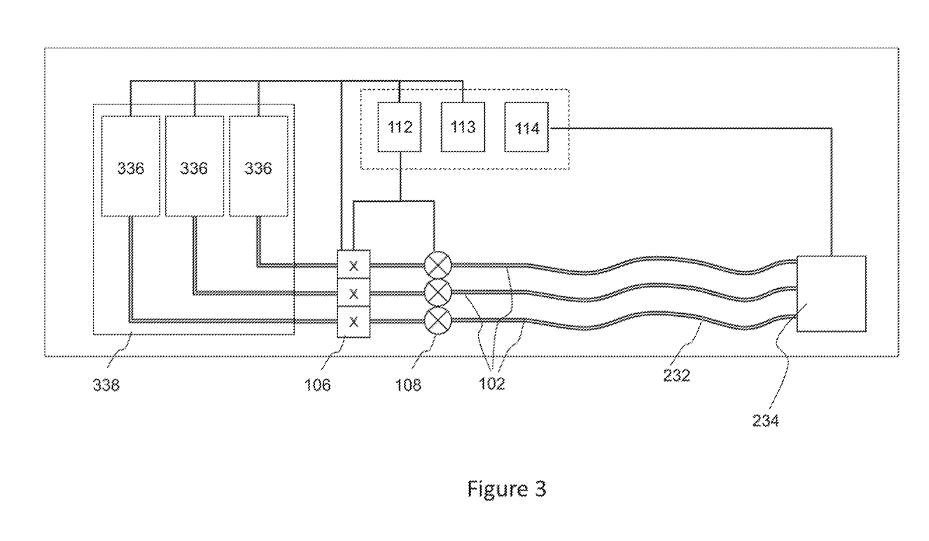

FIG. 3 shows a further example of a print device 300, in particular an inkjet printer, which differs from the print device 200 of FIG. 2 in that there are a plurality of print fluid supply pathways 102 for respective print fluids, each print fluid supply pathway 102 coupled to a respective print fluid reservoir and print fluid supply. For clarity, the individual reservoirs, supplies and pumps for each print fluid are shown simply as supply apparatus 336 within a print fluid supply cabinet 338. As shown in FIG. 3, each print fluid supply pathway is provided with a respective pressure sensor 106 and valve 108. In this example there is a single pressure sensor controller 112 which is coupled to each of the valves 108 and sensors 106 accordingly and is to control each valve and sensor pair independently. In other examples there may be a plurality of pressure sensor controllers 112.

In other examples the print devices 200, 300 described above with respect to FIGS. 2 and 3 respectively may be a 3D printer. 3D printer may have the same features and configuration as described above with respect to FIGS. 2 and 3. Such 3D printers may have a print fluid supply pathway extending from a reservoir inlet to a printhead disposed in an article chamber to convey a print fluid such as a binding agent. The moveable carriage and printhead may be controllable to traverse the article chamber during a print operation and discharge print fluid onto a substrate, such as a layer of powder for an article. In use, the binding agent may be discharged through the printhead in the article chamber to locally bind a substrate during a 3D print operation.

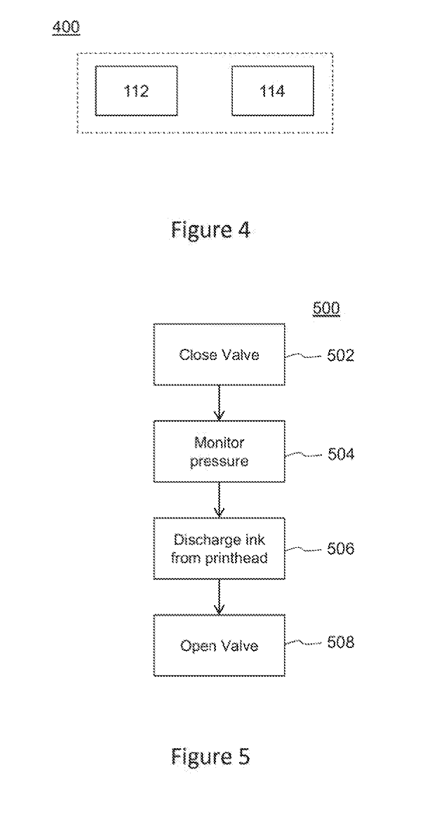

FIG. 4 shows a print device controller 400 comprising a pressure sensor controller 112 and a print operation controller 114. The print device controller 400 may be integral with a print device 100, 200, 300 as described above, or may be provided separately. In this example, the print operation controller 114 is to control print operations of a print device for which instructions may be received from, for example, an attached or remote computer, storage media, or (at least in the case of an inkjet printer) a scanner module of the print device which may scan an image for reproduction. For example, the print operation controller 114 may control the movement of a moveable carriage and the operation of nozzles of an associated printhead to eject droplets of print fluid onto a substrate.

The pressure sensor controller 112 may have a pressure monitor module 402 to monitor pressure of print fluid in a respective print fluid supply pathway 102 of a print device. The pressure sensor controller may have a valve control module 404 to temporarily dose a valve in the print fluid supply pathway 102 for a closed period, and to monitor the pressure of print fluid upstream of the valve 108 during the closed period. In this example, the pressure sensor controller 112 is to receive a pressure signal from the pressure sensor 106 during the closed period. In some examples, the pressure sensor controller 112 may process the pressure sensor signal to determine a property or status of the print fluid supply pathway or associated apparatus, as will be described below. In this example, the pressure sensor controller 112 is to control the closing and opening of the valve 108 so that the closed period is no more than is long. In other examples, the closed period may be no more than 0.7 s, no more than 0.5 s, no more than 0.3 s, or no more than 0.2 s in duration.

The print device controller 400 may comprise a processor 406 and a memory 408 for executing and storing computer readable instructions for controlling the valve and monitoring pressure.

The print device controller 400 may control a print operation of an inkjet printer or a 3D printer.

FIG. 5 is a flowchart setting out an example of a method 500. In block 502, a valve of a print fluid supply pathway of a print device downstream of a print fluid reservoir is closed. For example, the print device may be an inkjet printer or a 3D printer, The closure of the valve initiates a closed period of the valve. In block 504, the pressure of print fluid in the print fluid supply pathway upstream of the valve is monitored whilst the valve is closed, for example, using a pressure sensor upstream of the valve. In block 506, print fluid is discharged from a printhead during the dosed period of the valve. In this example, the discharge of print fluid from the printhead is controlled independently to the closure of the valve, such that a print operation in which print fluid is discharged continues during the closed period, despite the closure of the valve. It will be appreciated that the order of blocks 504 and 506 is variable and print fluid discharge may occur before, during or after pressure monitoring. In block 508, the valve is opened and the closed period terminates. It will be appreciated that the discharge of print fluid form the printhead may continue irrespective of the termination of the closed period.

In this example, the pressure is monitored only during closed periods of the valve. In other examples, the pressure may additionally be monitored outside of closed periods of the valve.

In some examples, the method of FIG. 5 may be carried out by a print device 100, 200, 300 or print device controller 400 as described above with respect to FIGS. 1-4.

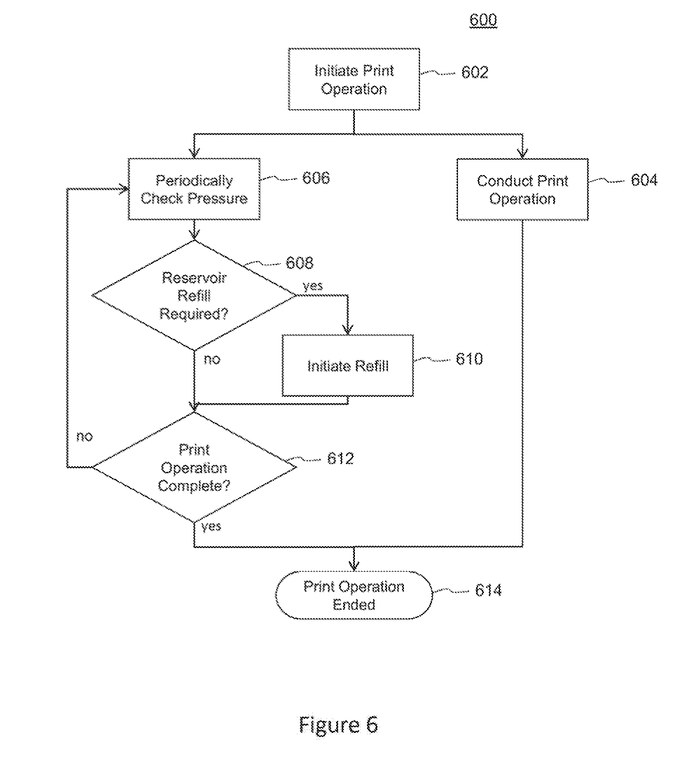

FIG. 6 is a flowchart setting out a further example of a method 600, which is described by reference to the print device 200 of FIG. 2.

In block 602, a print operation is initiated by the print operation controller 114 receiving a print instruction from a remote computer. In block 604, the print operation controller 114 causes the print operation to be carried out, for example, by moving the moveable carriage of the print device 200 and controlling the printhead 234 to discharge droplets of print fluid onto a substrate in a pattern corresponding to an image or article to which the print instruction relates. In this example, the average flow rate of print fluid along the print fluid supply pathway 102 during the print operation is approximately 25 ml per minute. In other examples, the flow rate may be higher or lower, for example between 0 ml and 100 ml per minute. It will be appreciated that the flow rate depends on the content to which a print instruction relates.

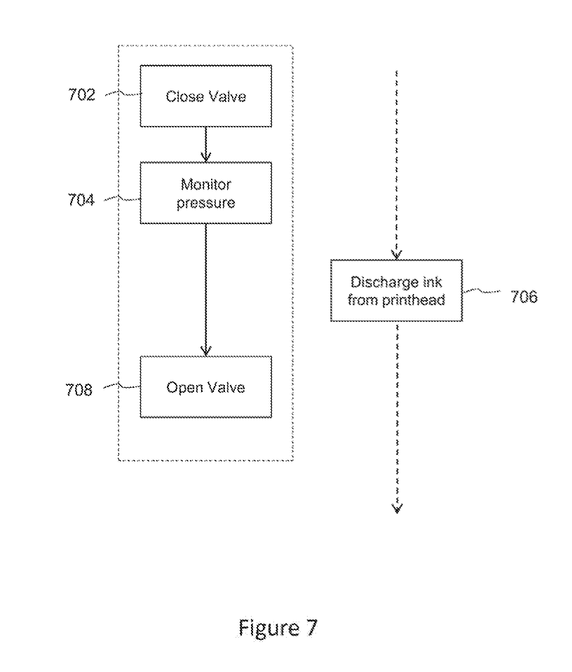

Concurrently, in block 606 the pressure sensor controller 112 periodically checks the print fluid pressure during the print operation, as will be described below with reference to FIG. 7. In this example, the pressure sensor controller 112 initiates a print fluid pressure check at 2 s intervals during the print operation.

In block 608, the refill controller 113 determines based on the print fluid pressure whether refill of the print fluid reservoir 216 from the print fluid supply 226 is due. For example, if the print fluid pressure is below a threshold, for example, below 10 k Pa gauge (1.5 Psi), the refill controller 113 may initiate a re-fill operation (block 610).

In block 612, the refill controller 113 determines whether the print operation is complete, for example, by reference to an output of the print operation controller 114. If the print operation is not complete, the method returns to block 606 for repetition of the pressure and refill checking loop whilst the print operation continues. When it is determined that the print operation is complete, the loop terminates (block 614).

FIG. 7 shows a method of pressure monitoring corresponding to block 606 of FIG. 6. In block 702, the valve 108 in the print fluid supply pathway 102 is closed, thereby initiating the closed period. In block 704, the print fluid pressure is monitored using the pressure sensor 106. In block 706, print fluid from the respective print fluid supply pathway 102 is discharged from the printhead 234 as part of the independently controlled print operation (block 604 of FIG. 6), during the closed period of the valve 108. In block 708, the valve 108 is reopened, thereby ending the closed period. In this example, the closed period is 1 s. During the closed period, print fluid within the print fluid supply pathway downstream of the valve 108 is discharged from the printhead, whilst there is no print fluid flux upstream of the valve 108. Print fluid which is discharged may correspond to print fluid stored in the printhead or in the print fluid supply pathway to the printhead 234, such as in the flexible tubing 232.

The applicant has found that a print operation can continue in which print fluid is discharged from a printhead despite a valve in the respective print fluid supply pathway being closed for a dosed period, for example, by discharging print fluid in the downstream part of the print fluid supply pathway. The closed period can be set so that the pressure may stabilize upstream of the valve, and so that the printhead downstream of the valve does not experience a loss of print fluid supply. A suitable minimum duration of the closed period may depend on the speed of closing of the valve, amongst other things, and may be set based on monitoring pressure in a test print device after valve closure. The closed period may be at least 0.1 s, for example at least 0.2 s or 0.3 s. A suitable maximum duration of the closed period may depend on factors such as the volume of print fluid in the print fluid supply pathway downstream of the valve which may be drawn upon by the printhead during the closed period of the valve. Again, a suitable maximum duration may be set based on monitoring printhead performance during a closed period of the valve in a test print device. A suitable maximum duration of the closed period may be no more than 1 s, no more than 0.7 s, no more than 0.5 s or no more than 0.3 s.

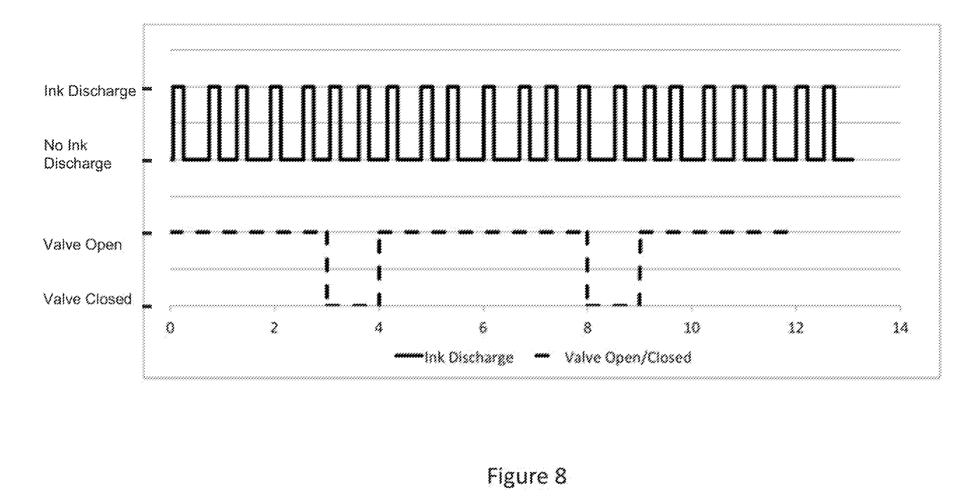

FIG. 8 shows an example plot of concurrent ink discharge and pressure monitoring in a print device, which in this example is an inkjet printer, as described above. The plot shows ink discharge periods of approximately 0.2 s separated by gaps of between 0.3 s and 0.5 s. Concurrently, a valve in the corresponding ink supply pathway is closed for two closed periods, each lasting is and separated by 2 s intervals. It will be appreciated that the example ink discharge and pressure monitoring profiles may equally correspond to print fluid (e.g. binding agent) discharge and pressure monitoring profiles of a 3D printer.

Although an example has been described in which pressure monitoring is conducted to check a reservoir status of a print fluid reservoir and determine whether reservoir refill is due, it will be appreciated that in other examples pressure monitoring may be used for other and/or multiple purposes.

Although an example has been described in which print fluid pressure is monitored during a print operation, it will be appreciated that in examples print fluid pressure may also be monitored outside of a print operation, for example, during diagnostic tests and during startup and shutdown procedures of a print device.

Although example methods have been described in which print fluid corresponding to a print fluid supply pathway is discharged during a closed period of a respective valve, it will be appreciated that in use print fluid may not be discharged during each and every closed period of a valve, but that such discharge of print fluid occurs for at least some closed periods.

The expression large format printer is intended to indicate printers that are capable of receiving and printing on large size sheet media, such as A1 and above. Such printers may also be capable of printing long plots, e.g. printing on sheet media which is relatively long (around 1-2 m or longer). Some large format printers are capable of receiving and printing on sheet media of more than 3 m in width, such as 3.2 m (126 inches) wide.

Examples in the present disclosure can be provided as methods, systems or machine readable instructions, such as circuitry or a combination of circuitry and executable machine readable instructions. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors. The controllers 112, 114, 400 and/or modules 402, 404 described above may each comprise a processor and/or a memory.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A print device comprising;
a print fluid supply pathway extending from a reservoir inlet to a printhead outlet;
a valve in the print fluid supply pathway downstream of the reservoir inlet;
a pressure sensor to monitor print fluid pressure upstream of the valve;
a pressure sensor controller to temporarily close the valve for a closed period and monitor print fluid pressure using the pressure sensor during the closed period; and
a print operation controller to control printing operations of the print device so that in use a printing operation continues and print fluid is discharged from a printhead during a closed period of the valve in the respective print fluid supply pathway,

2. A print device according to claim 1, further comprising a print fluid reservoir coupled to the reservoir inlet of the print fluid supply pathway.

3. A print device according to claim 1, further comprising a printhead coupled to the printhead outlet of the print fluid supply pathway.

4. A print device according to claim 1, wherein the pressure sensor controller is to temporarily close the valve for a closed period of no more than 1 second.

5. A print device according to claim 1, further comprising a refill controller to control refilling of a print fluid reservoir coupled to the reservoir inlet from a print fluid supply based on monitoring print fluid pressure.

6. A print device according to claim 1, comprising a plurality of print fluid supply pathways and associated reservoir inlets and printhead outlets, wherein for each print fluid supply pathway the print device comprises:
a valve in the respective print fluid supply pathway downstream of the respective reservoir inlet;
a pressure sensor to monitor print fluid pressure upstream of the valve;
a pressure sensor controller to temporarily close the valve for a closed period and monitor pressure using the pressure sensor during the respective closed period;
wherein each pressure sensor controller is to dose the respective for a dosed period independently of other pressure sensor controllers.

7. A print device according to claim 1, comprising an inkjet printer.

8. A print device controller comprising:
a pressure sensor controller comprising a valve control module and a pressure monitor module, wherein:
the valve control module is to control a valve closure operation in which a valve in a print fluid supply pathway of a print device downstream of a print fluid reservoir is temporarily closed for a dosed period; and
the pressure monitor module is to monitor print fluid pressure upstream of the valve during the closed period; and
a print operation controller to control printing operations of a print device so that in use a printing operation continues and print fluid is discharged from a printhead during a closed period of the valve in the respective print fluid supply pathway,

9. A method comprising:
closing and opening a valve in a print fluid supply pathway of a print device downstream of a print fluid reservoir so that the valve is temporarily closed for a closed period;
monitoring print fluid pressure upstream of the valve during the closed period;
discharging print fluid received from the print fluid supply pathway from a printhead, of the print device downstream of the valve during the closed period.

10. A method according to claim 9, wherein the valve is temporarily closed for a closed period of not more than 1 second.

11. A method according to claim 9, wherein the valve is temporarily closed for a closed period of at least 0.1 seconds.

12. A method according to claim 9, wherein the pressure is only monitored when the valve is closed.

13. A method according to claim 9, further comprising refilling a print fluid reservoir coupled to the print fluid supply pathway based on monitoring print fluid pressure.

14. A method according to claim 9, wherein print fluid is discharged during the closed period as part of a print operation, and wherein the print operation is controlled independently of the valve so that the print operation continues when the valve is temporarily closed.

15. A method according to claim 10, further comprising determining a reservoir status based on monitoring print fluid pressure.
